(19) United States
(12) Patent Application Publication
(10) Pub. No.: US 2010/0191465 A1
(43) Pub. Date: Jul. 29, 2010

(54) METHOD AND SYSTEM FOR OUTPUTTING NAVIGATION INSTRUCTIONS

(76) Inventors: Stefan Noll, Laatzen (DE); Guido Mueller, Quedlinburg (DE); Guido Stuebner, Hannover (DE)

Correspondence Address: KENYON & KENYON LLP, ONE BROADWAY, NEW YORK, NY, 10004, US

(21) Appl. No.: 12/450,854

(22) PCT Filed: Mar. 26, 2008
(86) PCT No.: PCT/EP2008/053534

§ 371 Date: Mar. 18, 2010

(30) Foreign Application Priority Data
May 22, 2007 (DE) 10 2007 023 765.2

(51) Int. Cl. G01C 21/36

(52) U.S. Cl. 701/210

(57) ABSTRACT

A method is provided for outputting an item of directional information, which corresponds to an item of location information displayed on a traffic sign, which location information is assigned to a section of the route that follows when viewed from a current section of a route, and in the case of a plurality of items of location information assigned to the following route section, preferably the particular item(s) of location information is/are used as basis for the output of the directional information that exhibit(s) the greatest frequency for the route sections following the following route section, as well as a system for implementing the method.

### BACKGROUND OF THE INVENTION

1. Field of the Invention

The present invention relates to a method and a system for outputting directional information.

2. Description of Related Art

Generally known vehicle navigation systems calculate a travel route from a vehicle location, which is determined by a position finding device, to a destination, which is specified by the user/vehicle driver, on the basis of stored road map data using a best-path algorithm. On the basis of this driving route and a particular vehicle location, which is determined repeatedly in the course of the travel along the driven route, navigation instructions are output to the vehicle driver, which guide him along the route. These navigation instructions could be reproduced acoustically in the form of, for example, “turn right at the next intersection and then follow road x”, via loudspeakers connected to the navigation system.

A generic method is described in the German patent publication DE 10 2005 049 769. In this case navigation instructions, which include a designation of a roadway to be traveled, are output. To make it easier for the driver to orient himself, if there are several possible designations of the road to be traveled, the particular designation that is the same for a plurality of consecutive roadway sections is preferably output.

### BRIEF SUMMARY OF THE INVENTION

The present invention advantageously makes it easier for a driver to orientate himself within a road network.

To this end, the directional or navigation instructions output by a navigation system as an example for a system according to the present invention advantageously include location information that is displayed on traffic signs erected along the driven route. If a plurality of location information items pertaining to the section of the route that directly follows the currently driven route section is involved, the driver is assisted especially by the fact that from among the plurality of items of location information, the particular location information that has the greatest frequency for the route sections directly following the next route section is used as basis for the output of directional information.

In the ideal case, the number of items of location information to be output as part of the directional information is thereby able to be reduced to a single item of location information, which furthermore remains unchanged for a plurality of successive route sections, and thus the directional information, in the further course of the route. The information overload for the user is thereby restricted. In addition, the user is advantageously able to orient himself on the basis of location information that remains the same at least for certain stretches, which has also been shown to reduce the stress considerably.

The location information may be, in particular, the information about far and near destinations appearing on information signs along the highway, which are able to be reached via a current road section or a diverging route section. In the same way the location information could also be information about inner-city destinations, such as a town center, an infrastructure facility such as a zoo, hospital, train station or the like.

To determine the location information on which the output of directional information is to be based, the route is analyzed starting from the destination up to an instantaneous position. The analysis preferably takes into account all location information on traffic signs appearing along the route, and determines the frequency of the occurrence of each individual item of location information of each traffic sign.

It is advantageous if the determination of location information to be used as basis for an item of directional information is triggered anew once a section of the route has been traveled. As an alternative or in addition, the determination of the location information on which the directional information is to be based is advantageously able to be triggered anew once a traffic sign bearing an item of location information has been passed.

The determination of location information to be used as basis for the directional information is advantageously based only on substantially similar traffic signs.

### BRIEF DESCRIPTION OF SEVERAL VIEWS OF THE DRAWING

FIG. 1 shows a block diagram of a system according to the present invention for implementing the method of the present invention, using a vehicle navigation system as example.

FIG. 2 shows schematically, a detail of a traffic route network, specifically a roadway network in this case, with whose aid the method of functioning of the present invention will be described in the following text.

FIGS. 3A, 3B and 3C show exemplary information signs placed along the route.

### DETAILED DESCRIPTION OF THE INVENTION

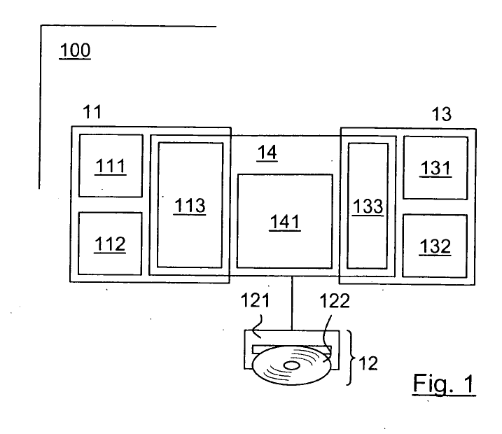

100 in FIG. 1 denotes a navigation system according to the present invention for executing the method of the present invention. Navigation system 100 includes a position-finding module 11 to determine a current location and thus to determine the current location of its user. For example, it evaluates signals from a GPS receiver 111 and optionally from additional position-determination means such as acceleration sensors 112, and uses them to determine positional data with the aid of a software module 113, which is processed by a central control 14 of the navigation device, for instance.

In addition, navigation device 100 includes a digital map 12 in which, for example, information about roadways able to be used by a motor vehicle is included. Digital map 12 preferably may be developed in the conventional manner as CD-ROM or DVD-ROM 122, which is read with the aid of a corresponding disk drive 121 of navigation device 100. The map data also include information about information displays 21, 22, 23 and 24 placed along roadway sections 1, 2, 3, 4 and 5, and about their information content or lettering. If information signs on highways are involved, these are, among others, the names of towns, which correspond to endpoints of the various highway sections listed in the network of federal highways. More specifically, these information signs provide additional information about locations that may be reached via the particular route section. In the same way, the location information may however also relate to information about inner-city destinations such as a town center, an infrastructure facility such as a zoo, hospital, train station or the like, or also out-of-town destinations, such as the name of villages and townships, adventure parks, special attractions such as fortresses and castles, water reservoirs or the like.

In addition, navigation system 100 has a user interface 13 including input means 131 such as a push-button switches or other operating elements such as, for instance, a voice input module or a touch-sensitive screen, as well as output means 132 in the form of a display, and/or an acoustic output module. For one, the user interface is used by the user for inputting the destination, and for another, for navigation along a route calculated by the navigation system, for example by outputting acoustic or visual navigation instructions, which are also referred to as directional information in this application.

Navigation system 100 also has a central control 14, which is implemented in the form of a program-controlled computing device. In addition to position-finding module 11, another software module 133 controls user interface 13, i.e., the communication of the navigation device with the user. Finally, a third software module 141 controls the exchange of information and the information processing within navigation system 100, among them the route calculation, by utilizing the map data, with the aid of a shortest path algorithms such as Ford-Moore, and also the method according to the present invention.

A travel route 10 calculated by the navigation system once Dortmund has been input as the travel destination via input means 131, leads from Hildesheim, Robert-Bosch Street, for example, to the town center of Dortmund. The route runs from Hildesheim via the highway interchange Hildesheim on highway A7, via highway A7 in the northern direction up to highway interchange Hannover-East, where highways A7 and A2 cross, from there via highway A2 in the westward direction via highway junction Hannover-Burgdorf, where highways A2 and A37 cross, up to the junction Dortmund-Northeast on highway A2, and from there to Dortmund using federal highway B236.

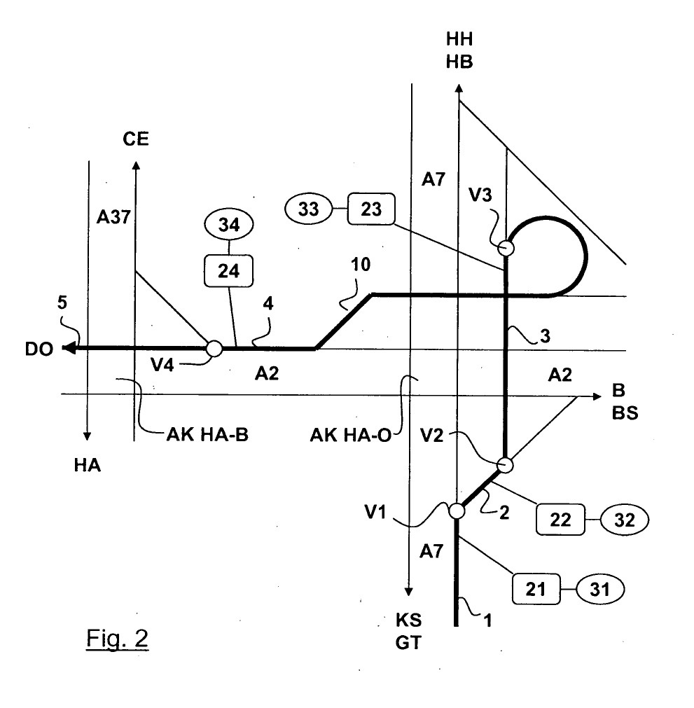

FIG. 2 schematically illustrates a detail of the roadway network that includes the two aforementioned highway junctions and has the route course marked. A7 denotes highway A7 with the driving direction Hamburg HH and Bremen HB as well the opposite direction Kassel KS and Göttingen GT; A2 denotes highway A2 with the driving directions Berlin B and Braunschweig BS as well as Dortmund DO; A37 denotes highway A37 with the driving directions Celle CE and Hannover HA, and HA-0 finally denotes highway interchange Hannover-East and HA-B highway interchange Hannover-Burgdorf. Appearing in bold outline in this detail of the road network is a section of aforementioned route 10 calculated by the vehicle navigation system. It is made up of successive sections 1, 2, 3, 4 and 5, which sections are delimited by individual potential branch-off points V1, V2, V3, V4 from the route. Section 1 is the stretch of highway entry ramp Hildesheim onto A7 up to the exit from A7 at highway interchange Hannover-East HA-0. Further section 2 is defined by the exit from highway interchange Hannover-East HA-0 of A7 and the subsequent turn-off lane up to point V2 where the turn-off lane is followed further in the direction of branch-off point V3 or, alternatively, it is possible to turn off from the turn-off lane in the direction A2, Berlin. Further route section 3 is defined by branch-off point V2 and further branch-off point V3 on the turn-off lane, where it is possible either to go straight to reenter A7 in the direction of Hamburg or, alternatively, it is possible to make a right turn off the turn-off lane according to the course of the route in order to enter the A2 in the direction of Dortmund. Fourth route section 4 extends from third branch-off point V3 to next branch-off point V4 where A2 may be exited onto A37 in the direction of Hannover or Celle or, alternatively, A2 may be followed further in the direction of Dortmund in accordance with the course of the route. Fifth route section 5 follows the fourth route section.

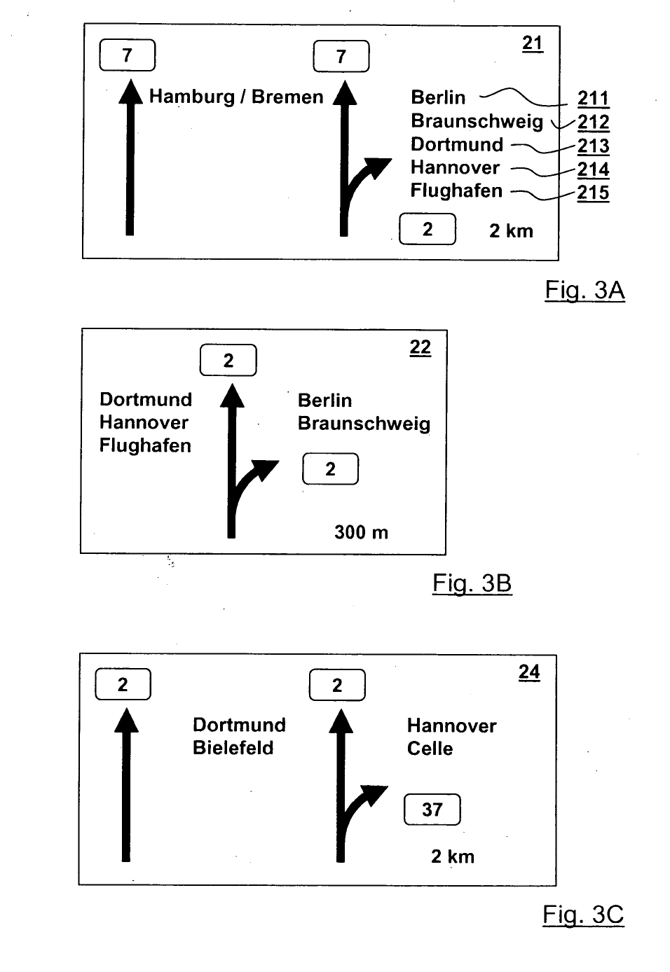

On a highway directional sign 21 according to FIG. 3A, hereinafter “sign 1”, which is situated along the route before highway junction Hannover-East when traveling from the direction of Hildesheim, in the region of route section 1, such as approximately 2 km before exit V1 from A7, the location information or directional driving information can be found

Hamburg as well as Bremen in case that A7 is followed further,

Berlin 211, Braunschweig 212 as well as Dortmund 213, Hannover 214, airport 215 in case that A7 is left at the highway junction Hannover-East.

Highway directional sign 21 according to FIG. 3A is shown schematically as are additional signs 3B and 3C, and no claim is made to correspondence with the real sign postings. The described positions or placements of the signs are made up as well.

On a further directional sign 22 according to FIG. 3B, hereinafter “sign 2”, which is situated directly before or on turn-off lane 2 from A7, the location information or directional information is encountered

Berlin, Braunschweig in case that an immediate further turn is made off the turn-off lane, so that travel would then proceed on A2 in the eastward direction,

Dortmund, Hannover, airport in case that the turn-off lane is left only at the next following possibility, so that A2 would be traveled in the westward direction.

On a further directional sign 24 according to FIG. 3C, hereinafter “sign 4”, which is situated along the route before the highway junction Hannover-Buchholz when traveling from the direction of Hildesheim, in the region of fourth route section 4, location information or directional driving information are found

Dortmund, Bielefeld in case that A2 is followed further,

Hannover as well as Celle in case that A2 is left at highway junction Hannover-Burgdorf.

Before or at branch-off point V3, i.e., the location at which the route turns off from the turn-off lane of A7 in the direction of A2, Dortmund/Hannover, another directional sign 23 is installed, hereinafter “sign 3”, which provides the directional information

Dortmund, Hannover, airport in case that the turn-off lane is left, so that A2 would be traveled further in the westward direction.

The directional information described here includes as essential components location information, in the case at hand, the names of towns, which correspond to end points of the various highway sections listed in the map of the federal highway system. Specifically, these are the town names Hamburg for the viewed section of the A7, Berlin and Dortmund for the viewed section of the A2, and Hannover for the A37. In addition, in some cases location information for closer lying important points along these highway sections is provided as well, such as Braunschweig for the A2 in the eastward direction, Hannover, airport and later Bielefeld for the A2 in the westward direction.

The method according to the present invention generates the navigation instructions it is to output for the navigation, also directional information, by utilizing or incorporating location information displayed on the information signs. Only location information from a traffic sign that pertains to the course of the route, and not only to a specific point along the route, is taken into account. Directional information not pertaining to the course of the route is disregarded. The display of the directional information would then include the following location information.

On section 1, in the travel direction along the route before or at sign 1 according to FIG. 3A (directional information 31) : “ . . . direction of Dortmund” instead of, for example, “ . . . direction of Berlin, Braunschweig, Dortmund, Hannover, airport . . . ”,

In section 2, before sign 2 according to FIG. 3B (directional information 32): “ . . . direction of Dortmund” instead of, for instance, “ . . . direction of Dortmund, Hannover, airport . . . ”.

In section 3, before sign 3 (directional information 33): “ . . . direction of Dortmund” instead of, for instance, “ . . . direction of Dortmund, Hannover, airport . . . ”.

In section 4, before sign 4 according to FIG. 3C (directional information 34): “ . . . direction of Dortmund” instead of, for instance, “Dortmund, Bielefeld . . . ”

The complete driving instructions could then read:

In section 1, in the travel direction along the route before or at sign 1 according to FIG. 3A: “Turn right at the next exit and follow the A2 in the direction of Dortmund”.

In section 2, before sign 2 according to FIG. 3B: “Stay in the turn-off lane in the direction of Dortmund”.

In section 3, before sign 3: “Now turn right in the direction of Dortmund and continue on A2 in the direction of Dortmund”.

In section 4, before sign 4 according to FIG. 3C: “Continue on A2 in the direction of Dortmund”.

This display may be achieved, for example, by analyzing the route starting from the destination to the current position. The analysis preferably considers all location information on traffic signs appearing along the route, and determines the frequency of the appearance of each individual item of location information of each traffic sign. In the described example, the result of the analysis would look like this.

| | | | | | frequency of the |
|---|---|---|---|---|---|
| Location | | | | | location |
| Information | sign 4 | sign 3 | sign 2 | sign 1 | information |
| Berlin | | | | x | 1 |
| Bielefeld | x | | | | 1 |
| Braunschweig | | | | x | 1 |
| Dortmund | x | x | x | x | 4 |
| Airport | | x | x | x | 3 |
| Hannover | | x | x | x | 3 |

Due to the fact that Dortmund is the most frequently found location information on the traffic signs along the route and on the information display sign 1 coming up next to the vehicle location, Dortmund is selected as the obviously most important location information on sign 1 for the user/vehicle driver for the directional information to be generated subsequently.

This analysis is preferably performed for the first time after completion of the route calculation in control 14 by software 141. After completion of the route calculation the route is available as sequence of successive route sections in a memory of navigation system 100, preferably in the working memory of control 14. To perform the analysis, location information available on the map in connection with the stored route sections, which is indicated on the traffic signs along the route, is read out and the analysis is performed on the basis of this information.

One advantageous further development of the present invention provides that the aforementioned analysis is performed not only once at the beginning of the navigation or after completion of the route calculation, but preferably repeatedly. It is possible, for instance, to trigger the analysis anew in each instance once an individual route section has been passed or traveled. The frequency distribution of the location information may change in the course of the route, for example if the route branches off from an initially traveled highway to a different highway.

As an alternative or in addition, the determination of the location information on which the directional information is to be based is able to be triggered anew once a traffic sign bearing an item of location information has been passed.

According to one specific embodiment of the present invention, the determination of the location information to be used as basis for the directional information is based only on traffic signs of the same type, i.e., for instance, only directional information signs but not, for example, distance signs on which distance information pertaining to locations able to be reached via the currently traveled road, appears. As an alternative, however, these distance displays or other signs bearing other location information may be taken into account as well for the purpose of determining the relevant location information.

1-6. (canceled)

7. A method for outputting to a driver of a vehicle an item of directional information, comprising:
providing, for a selected item of location information among multiple items of location information displayed on a traffic sign along a travel route having multiple route segments, at least one selected item of directional information associated with the selected item of location information as an output, wherein the selected item of location information is assigned to an immediately subsequent route segment of the travel route when viewed from a current route segment of the travel route;
wherein, if multiple items of location information are assigned to the immediately subsequent route segment of the travel route, an item of location information exhibiting the greatest frequency of association with the immediately subsequent route segment and further subsequent route segments of the travel route is determined and used as a basis for selecting the at least one item of directional information as the output.

8. The method as recited in claim 7, wherein the multiple items of location information include the names of places able to be reached via the immediately subsequent route segment.

9. The method as recited in claim 8, wherein the determination of the item of location information used as the basis for selecting the at least one item of directional information as the output is performed each time the vehicle has traveled past a route segment of the travel route.

10. The method as recited in claim 8, wherein the determination of the item of location information used as the basis for selecting the at least one item of directional information as the output is performed each time the vehicle has traveled past a traffic sign bearing an item of location information.

11. The method as recited in claim 10, wherein the determination of the item of location information used as the basis for selecting the at least one item of directional information as the output is performed each time the vehicle has traveled past traffic signs of the same type.

12. A system for outputting an item of directional information to a driver of a vehicle, comprising:
a memory unit storing, for an item of location information displayed on a traffic sign along a travel route having multiple route segments, information representing traffic route segments associated with the item of location information, wherein, for a selected item of location information among multiple items of location information displayed on a traffic sign along the travel route having multiple route segments, at least one selected item of directional information associated with the selected item of location information is provided as an output, wherein the selected item of location information is assigned to an immediately subsequent route segment of the travel route when viewed from a current route segment of the travel route; and
a control unit configured to determine and use, in the case multiple items of location information are assigned to the immediately subsequent route segment of the travel route, an item of location information exhibiting the greatest frequency of association with the immediately subsequent route segment and with further subsequent route segments of the travel route as a basis for selecting the at least one item of directional information as the output.
